(19) United States
(12) Patent Application Publication
(10) Pub. No.: US 2005/0116012 A1
(43) Pub. Date: Jun. 2, 2005

(54) Method for metal and alloy joining using bulk friction stir welding

(76) Inventors: Scott M. Packer, Alpine, UT (US); Tracy W. Nelson, Provo, UT (US); Carl D. Sorensen, Provo, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/997,044

(22) Filed: Nov. 24, 2004

Related U.S. Application Data
(60) Provisional application No. 60/525,322, filed on Nov. 26, 2003.

(51) Int. Cl. B23K 20/12

(52) U.S. Cl. 228/112.1

(57) ABSTRACT

A method comprising a bulk processing technique for joining different metals and alloys using friction stir welding, wherein a block of a first material has at least two apertures disposed therein, wherein at least a first tube and a second tube are disposed in the at least two apertures, wherein friction stir welding is performed to join the block, the first tube and the second tube together in a solid state form, and the resulting workpiece is then machined to produce the completed joint.

### CROSS REFERENCE TO RELATED APPLICATIONS

This document claims priority to, and incorporated by reference all of the subject matter included in the provisional patent application docket number 2880.AMP.PR, having Ser. No. 60/525,322 and filed on Nov. 26, 2003.

### BACKGROUND OF THE INVENTION

1. Field of the Invention

This invention relates generally to improved methods of joining metals and alloys utilizing the processes of friction stir welding. In friction stir welding (FSW), the heat for creating a weld is generated by plunging a rotating pin of a tool into a workpiece. The FSW process can now be used to provide a fundamentally improved joint when joining different metals and alloys.

2. Description of Related Art

Many different methods exist to join metals or alloys together. Joints can be formed using mechanical attachment devises such as bolts, screws, pins, rivets, or a significant number of variations of locking components. Mechanical joints can also be formed using a heat shrink or interference fit method. This involves heating a first component so it expands, sliding it over a second component, and then allowing the assembly to cool. By this method, the first component is mechanically secured to the second component.

Another method of joining two or more components together is using a fusion welding process. The process of fusion welding joins the components by creating a liquid phase or molten state of the components and subsequently forming a joint as they solidify together. There are many variations of the fusion welding process including laser welding, spot welding, TIG, flash butt welding, MIG, and others. All of these welding processes include a liquid phase.

A variation of fusion welding is the brazing process. Brazing involves using a lower melting material that melts to thereby join together higher melting metals, alloys or other materials as the molten braze freezes and forms a metallurgical bond. Brazing is used when fusion welding or other methods are not possible.

Friction welding is another method for joining materials together. Friction welding is a solid state joining process that allows two or more materials to diffuse together. One component is rotated against the other to generate sufficient heat to diffusion weld both components together.

Friction welding has been used in industry for years. It is a solid-state process that yields large economic benefits because it avoids many problems associated with rapid solidification of molten material that occurs in traditional fusion welding processes.

A variation of friction welding is friction stir welding (FSW) that uses a third body to generate sufficient frictional heat to join two or more materials together, as taught in U.S. Pat. Nos. 6,648,206 and 6,779,704. More specifically, it has been discovered that it is now possible to friction stir weld metal matrix composites, ferrous alloys, non-ferrous alloys, and superalloys using a superabrasive tool.

FIG. 1 is a perspective view of a tool as taught in the prior art that is being used for friction stir butt welding that is characterized by a generally cylindrical tool 10 having a shoulder 12 and a pin 14 extending outward from the shoulder. The pin 14 is rotated against a workpiece 16 until sufficient heat is generated, wherein the pin of the tool is plunged into the plasticized workpiece material. The workpiece 16 is often two sheets or plates of material that are butted together at a joint line 18. The pin 14 is plunged into the workpiece 16 at the joint line 18. The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that is generally indistinguishable from the workpiece material 16.

The prior art is replete with friction stir welding patents that teach the benefits of using the technique to obtain welds that have beneficial characteristics over contemporary fusion welding processes. These benefits include low distortion in long welds, no fumes, no porosity, no splatter, and excellent mechanical properties regarding tensile strength. Furthermore, the process has the advantage of using a non-consumable tool, no need for filler wire, no need for gas shielding, and a tolerance for imperfect weld preparations such as the presence of oxide in the weld region. The process is especially useful for preventing significant heat damage or otherwise altering the properties of the original material being welded.

However, it has long been a desire of industry to be able to weld materials that are presently functionally unweldable for friction stir welding. Thus, while friction stir welding is a very advantageous technique for welding non-ferrous alloys such as aluminum, brass and bronze, there has been no tool that is capable of functionally welding materials having higher melting points such as steel. It should be understood that functionally weldable materials are those that are weldable using friction stir welding in more than nominal lengths, and without destroying the tool.

Unfortunately, fusion welding alters or damages the alloy at the weld, thereby compromising the weld as a result of the defects or adverse phases which form in the weld during the welding process. In some cases, the non-metallic reinforcement material which has been joined with the original workpiece material to create the alloy is depleted at the weld. The result is a weld that has properties and characteristics which are different from the unaltered areas of the original workpiece material.

Until now, it has been the nature of friction stir welding that using a conventional friction stir welding tool or probe is worn down significantly so as to prevent functional welding of materials such as MMCs, ferrous alloys, and superalloys. Most tools simply do not work at all in MMCs, ferrous alloys, and superalloys. If a conventional tool could begin friction stir welding, the wear would be so significant that a probe would be torn apart after only a short distance. For example, some alloys will cause wear on a probe such that it can no longer function after welding for a distance of only inches.

Unfortunately, it is generally the case that it is not possible to simply insert a new tool and begin the friction stir welding process where the previous probe failed. If the weld is not continuous and uninterrupted, it is useless because of mechanical weakness. Furthermore, a portion of the tool is typically left behind in the workpiece material, also contributing to the mechanical weakness.

Therefore, it would be an advantage over the prior art to provide a new tool for use with the friction stir welding process that enables longer continuous and uninterrupted welding runs (functional welding) of materials such as steel for use in a bike frame that will cause a conventional tool to fail after a short distance. It would also be an advantage over the prior art if the new tool made it possible to friction stir weld materials that were previously too difficult to weld with conventional friction stir welding tools. It would also be an advantage to provide a tool that would enable friction stir welding with conventional workpiece materials, while exhibiting improved wear characteristics for the tool.

Even with the friction stir welding techniques that are available for use in the welding of high temperature materials for use in a bike frame, there are many cases where one of the above joining methods is used but not preferred. Many times mechanical methods require additional space and add weight. Sometimes mechanical methods are used because fusion joining is not possible with the material that must be used for the component in that application. For example, commercial aircraft components are joined with rivets because that particular aluminum alloy component is not fusion weldable. Great expense is incurred to use thousands of rivets that must be attached and formed to exacting tolerances on aircraft surfaces.

Many metals and alloys could be used for applications but cannot be joined mechanically or fusion welded. Fusion welding is sometimes not an option because of poor mechanical properties, distortion, corrosion problems, fatigue problems, etc.

FSW is one alternative but is limited to part geometry and the configuration of the equipment and fixturing. For example, a mandrel must support the part on the back side of the joint as the tool translates along the joint. This poses a significant problem for small radial joints or joints in hard to reach locations. FSW follows a joint with a tool as the component is supported on the back side with a stationary or rotating mandrel.

Accordingly, what is needed is a method of joining metals and alloys that can take advantage of the many benefits of friction stir welding.

### BRIEF SUMMARY OF THE INVENTION

It is an object of the present invention to provide a method for using friction stir welding to join different metals and alloys.

It is another object to provide a method for using friction stir welding to join different metals and alloys using a bulk processing technique.

It is another object to provide a method for joining two or more different metals and alloys together using Localized Deformation Assisted Bonding (LDAB).

It is another object to provide a method for joining two or more different metals and alloys together using friction stir welding that results in advantageous tailored or varied mechanical properties.

It is another object to provide a method for joining two or more different metals and alloys together using friction stir welding that results in lighter and stronger components.

It is another object to provide a method for joining two or more different metals and alloys together using friction stir welding, wherein the metals and alloys may be non-weldable using convention welding techniques.

It is another object to provide a method for joining components of a bike frame, wherein the components are first mechanically locked together before they are friction stir welded.

In a preferred embodiment, the present invention is a method comprising a bulk processing technique for joining different metals and alloys using friction stir welding, wherein a block of a first material has at least two apertures disposed therein, wherein at least a first tube and a second tube are disposed in the at least two apertures, wherein friction stir welding is performed to join the block, the first tube and the second tube together in a solid state form, and the resulting workpiece is then machined to produce the completed joint.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a prior art process for performing friction stir welding of high melting temperature materials.

FIG. 2 is a perspective view of a block having apertures disposed therein.

FIG. 3 is a translucent rendering of the block of FIG. 2 that indicates the depth of the apertures.

FIG. 4 is a translucent rendering of the block of FIG. 2 that illustrates two tubes disposed within the apertures.

FIG. 5 is a translucent rendering of the block of FIG. 2 that illustrates the bulk friction stir welding process being performed on the block and tubes.

FIG. 6 is a different view of the elements of FIG. 5.

FIG. 7 is a close-up, translucent, and perspective view of FIG. 5.

FIG. 8 is a perspective view of a completed and machined T-joint from FIG. 5.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Two or more components can be joined together using a bulk processing technique called Localized Deformation Assisted Bonding (LDAB). An explanation of this method to form a T-joint is provided as follows.

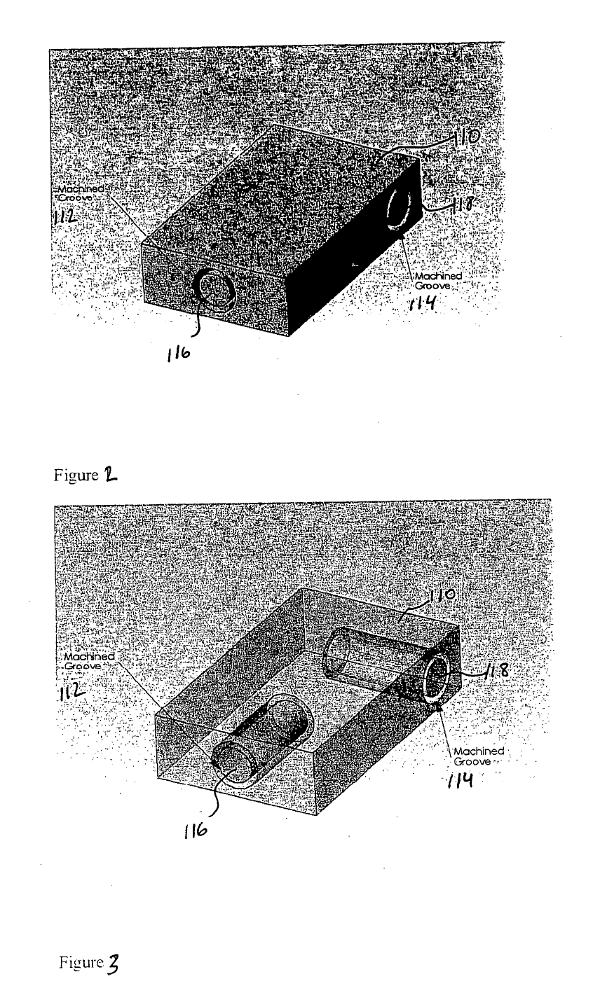

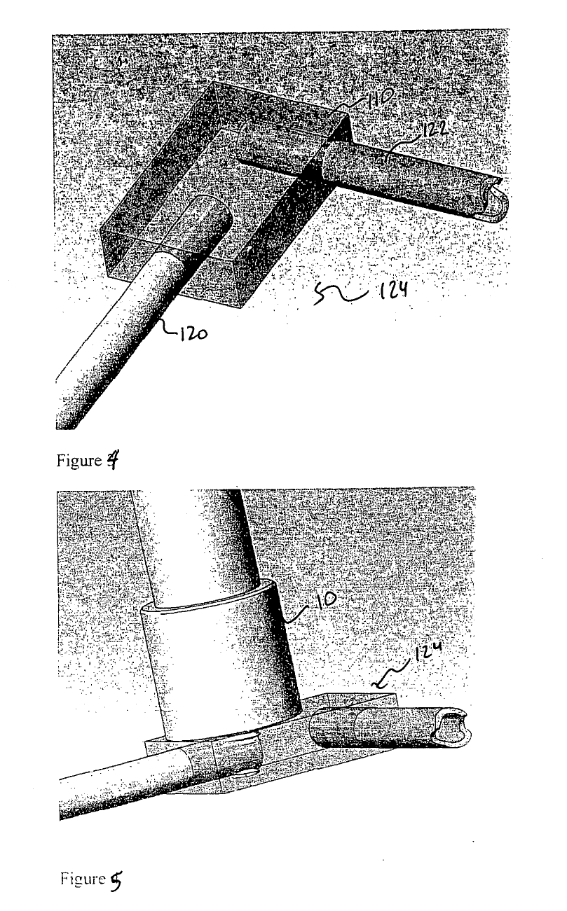

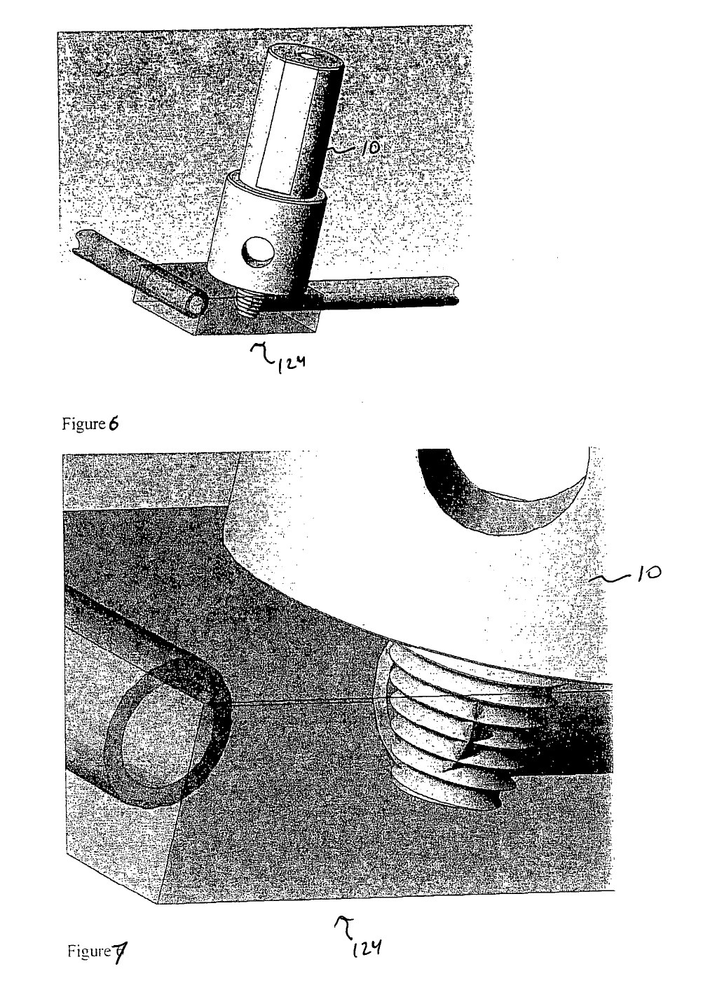

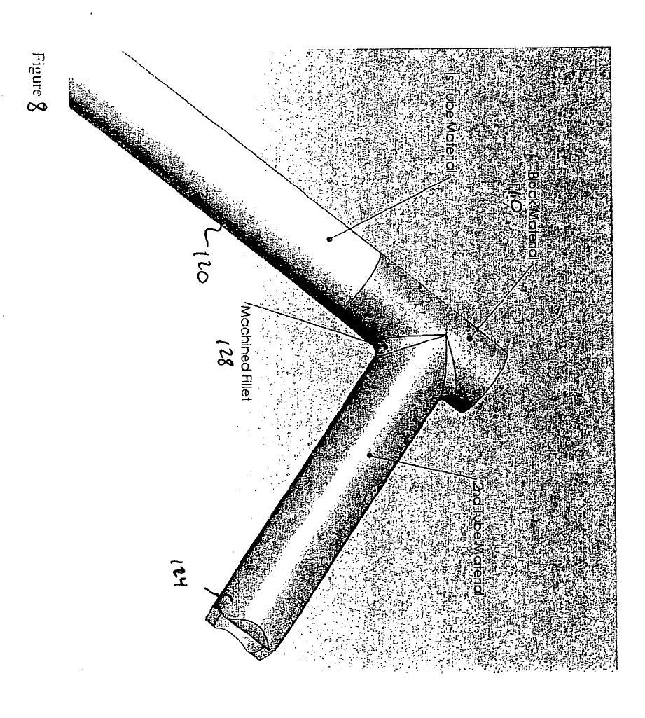

A T-joint of fusion weldable or non-fusion weldable alloys (or even a single alloy) can be formed by beginning with a block 110 made of a first alloy and shown in FIG. 2 (FIG. 3 shows translucent view of the block 110). Two circular grooves 112, 114 are machined to depth in the block 110 to create the joint locations. These grooves 112, 114 could be preformed, cast, forged, or formed in other methods and could be any shape, cross-section, solid, hollow or any variety of configurations. The block 110 can also have a variety of configurations. The rectangular shape is shown in FIG. 2 for illustration purposes only.

Notice also that the circular grooves 112, 114 have a center portion 116, 118 that has been left in the block 110. The purpose for leaving the center portions 116, 118 is to make the block a solid object with no gaps or voids when tubes are inserted into the block that might otherwise weaken the resulting object.

Alternatively, instead of leaving the center portions 116, 118 in the block, the circular grooves 116, 118 could be completely hollow, and the tubes instead in the grooves 116, 118 could instead be solid rods.

The materials of any tubes or rods that are joined to the block 110 could be constructed from an iron base, nickel base, aluminum, titanium, or a variety of metals and alloys including ferrous alloys such as stainless steel, and higher melting point super alloys that contain only small amounts of or no ferrous materials at all.

The location of a joint where tubes or rods are being coupled to the block 110 can also be modified by placing additional material at the joint that requires additional structural support. For example, the circular grooves 116, 118 might be hollow as described above. A different material might be inserted into the circular grooves 116, 118 or in the tubes (shown in FIG. 4) that can be inserted into the block 110.

Alternatively, the block 110 can have extensions that pass entirely through the block or on each end of the block as a means of structural support. In other words, the joint can be in a “middle” location of two tubes that meet or are adjacent to each other in the block 110.

As shown in FIG. 3, the block 110 is now shown in a translucent form to illustrate the nature of the circular grooves 112, 114 that are being used to illustrate the principles of the present invention. Note that the circular grooves 112, 114 extend only partially into the block 110. Alternatively, the circular grooves could extend all the way through the block 110, enabling a single tube or rod to be inserted therein, or even two tubes or rods inserted from each end.

In the present embodiment, a first tube 120 and a second tube 122, each potentially comprised of materials or alloys that are identical to or different from the material used in the block 110, are inserted into each of the machined grooves 112, 114 as shown in FIG. 4.

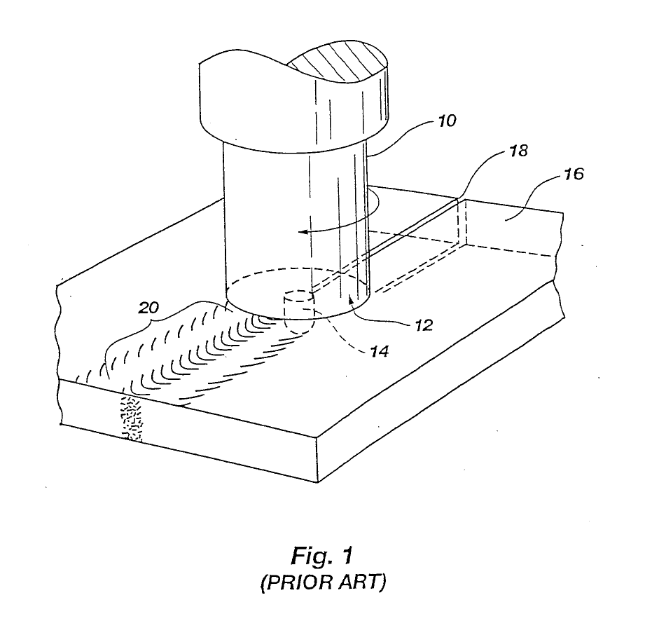

The assembly is then disposed on a friction stir welding machine having a tool 10 that rotates as described in FIG. 1. This tool 10 rotates and plunges into the surface of the block 110, and heats and mixes the alloy in a bulk processing manner as the tool traverses a length of the block. The tool 10 is traversed across the surface of the block 110 so that all of the components of the block and the tubes or rods 120, 122 are mixed and diffused in a solid state form. It may be necessary and the tool 10 is capable of processing both sides of the block 110. An assembly 124 comprised of the block 110 and the tubes or rods 120, 122 needs to be supported in order to accept the loads required to locally process the materials used in the assembly.

FIGS. 5, 6, and 7 illustrate the concept of using a friction stir welding tool 10 to mix and diffuse the material of the block 110 and the tubes 122, 124 together.

Once the assembly 124 becomes a single unit, it is disposed on a machining center and the material that is not needed to form the desired joint is machined away to form the structure shown in FIG. 8.

In the case of a T-joint, the exterior of the block 110 is machined away and the center of the tubes 120, 122 are bored to size. Both the exterior and interior of the block 110 can be machined to provide mechanical support for the assembly 124 with the use of fillets 126 (FIG. 8), smaller bore size for greater internal reinforcement, etc. High speed machining methods enable this method of joining because high volumes of material can be removed quickly and inexpensively. In some cases, it may not even be necessary to do finished machining if the bulk processed joint can meet design criteria. FIG. 8 shows the finished T-joint.

This joining method has several advantages over other joining methods. Non weldable alloys can be joined together to expand the range of materials that can be used for an application. Different materials and alloys can be used to form a joint of two or more components. Mechanical properties can be tailored and/or varied within a joined assembly to expand the assembly's range of use.

For example, a bicycle frame could be constructed with each tube made from a different alloy. One tube material could have greater compressive strength while another could have greater tensile strength. The wall thickness of the tubing can be thinner because the joint is not weakened by a fusion weld or mechanical fastener. Fillets can be machined at the joint sections to reduce or eliminate stress risers. This means a lighter, stronger component can be constructed with this joining method.

This bulk processing method also causes a finer grain structure in most alloys and increases the elongation. For example, if an aluminum alloy were joined together, this processing technique would cause grain refinement and the result would be an increase in elongation from approximately 12% to as much as 600%. If a joint failed, the strain to failure would be much greater and increase the possible applications where this joining technology could be applied.

A bulk processed joint can also be mechanically formed after it has been machined to expand the range of joint configurations because of the superplastic behavior of the bulk processed material.

A traditional welding paradigm is also challenged by changing from following a seam to fusion weld a joint to machining the resultant joint after bulk material has been processed. This means that tighter tolerances and intricate profiles for joints can be achieved. Some of the applications include, bicycle frames, snowmobile frames, motorcycles frames and components, aircraft structures, marine structures, I-beams, etc.

Another aspect of the present invention is the issue of mechanically coupling tubes or rods to a block. Mechanically coupling the structural members this way is important. The exact manner in which the mechanical coupling is caused to happen is not as critical. What is important is that the tubes and rods and the block to which they are being welded are held rigidly so that the components do not move during the friction stir welding process.

One method of preventing movement of the components is to thread the parts. For example, the circular grooves 112, 114 cut into the block 110 can be machined so that they are threaded. Similarly, the tubes 120, 122 would also be threaded so that the tubes are threaded into the circular grooves 112, 114. This mechanical bond provides significant support to the assembly 124 during friction stir welding, which can apply significant forces to the tubes 120, 122 and block 110.

Other methods of mechanically bonding or coupling the components together include using a pin, applying a welding braze, a compression fit where the block is heated until it expands, and then cooled after the tubes or rods are inserted therein, or any other similar means for obtaining a mechanical coupling.

An important application of the present invention is its use in the manufacturing of frames for use in bicycles. More specifically, very lightweight and yet rigid bicycle frames can be created using materials that are not typically used. For example, stainless steel is highly desirable for use as a bicycle frame, because of its strength and rigidity. However, while titanium and aluminum are often TIG (Tungsten Inert Gas) welded, this cannot be done for stainless steel. The state of the art of stainless steel bike frames typically is accomplished by brazing, a form of high temperature soldering, in combination with lugs which are sleeves that hold tubes of a frame at desired angles.

The present invention creates an entirely new dynamic for manufacturing stainless steel bicycle frames because the tubes can be welded by friction stir welding. Furthermore, lugs are now extraneous and the resulting bike frame is lighter because a joint is simply finished from the single assembly of tubes 120, 124 and block 110. As shown in FIG. 8, a machined fillet 128 gives added strength to joints.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for using friction stir welding to create a solid state joint for ferrous alloys, non-ferrous alloys, superalloys and high melting point materials, said method comprising the steps of:
(1) providing a block that is to be finished to create a joint, wherein the block is comprised of ferrous alloys, non-ferrous alloys, superalloys or high melting point materials;
(2) providing a first tube and a second tube to be joined to the block, wherein the first tube and the second tube are comprised of ferrous alloys, non-ferrous alloys, superalloys or high melting point materials;
(3) forming a first groove and a second groove in the block;
(4) disposing a portion of the first tube into the first groove, and disposing a portion of the second tube into the second groove; and
(5) functionally friction stir welding the first tube and the second tube to the block to thereby create a solid state assembly therebetween.

2. The method as defined in claim 1 wherein the method further comprises the step of machining the solid state assembly to remove unwanted material therefrom.

3. The method as defined in claim 2 wherein the method further comprises the step of boring apertures in the first tube and the second tube where they are joined together with the block, wherein the apertures meet within the assembly.

4. The method as defined in claim 3 wherein the method further comprises the step of machining at least one fillet in the assembly when removing unwanted material therefrom to thereby increase structural strength of the assembly.

5. The method as defined in claim 2 wherein the method further comprises the step of rigidly mechanically coupling the first tube to the block and the second tube to the block to thereby prevent movement of the first tube and the second tube when they are friction stir welded to the block.

6. The method as defined in claim 5 wherein the method further comprises the steps of:
(1) forming the first groove and the second groove to have a threaded groove along an inside diameter; and
(2) forming the first tube and the second tube to have a threaded length along an outside diameter where the first tube and the second tube are joined to the block, such that the first and second tubes can be mechanically screwed into the block.

7. The method as defined in claim 5 wherein the method further comprises the steps of:
(1) heating the block so that the block expands;
(2) inserting the first and second tubes into the first and second grooves of the heated and expanded block; and
(3) allowing the heated block to cool and contract around the first and the second tubes.

8. The method as defined in claim 5 wherein the method further comprises the steps of:
(1) disposing apertures through the block and the first tube, wherein the apertures are coaxial; and
(2) disposing a pin through the apertures to thereby hold the first tube in place within the block.

9. The method as defined in claim 6 wherein the method further comprises the steps of:
(1) disposing apertures through the block and the second tube, wherein the apertures are coaxial; and
(2) disposing a pin through the apertures to thereby hold the second tube in place within the block.

10. The method as defined in claim 1 wherein the method further comprises the step of selecting stainless steel for the material used in the block, the first tube and the second tube.

11. The method as defined in claim 1 wherein the method further comprises the steps of:
(1) forming the first and the second grooves with a circular cross-section; and
(2) forming the first and the second tubes with a circular cross-section.

12. The method as defined in claim 1 wherein the method further comprises the step of leaving a plug in the middle of the first and the second circular grooves, wherein the plugs slide into the first tube and the second tube when the first and second tubes are coupled to the block.

13. The method as defined in claim 1 wherein the method further comprises the step of selecting a shape for the block from any convenient shape that enables the first tube and the second tube to form a desired angle within the block.

14. The method as defined in claim 1 wherein the method further comprises the step of forming the first groove so that the first groove is disposed opposite of but coaxially aligned with the second groove.

15. The method as defined in claim 1 wherein the method further comprises the step of forming the first groove so that the first groove is disposed at an oblique angle with respect to the second groove.

16. The method as defined in claim 1 wherein the method further comprises the step of forming the first groove so that the first groove is disposed at a right angle with respect to the second groove.

17. A method for using friction stir welding to create a solid state joint for ferrous alloys, non-ferrous alloys, superalloys and high melting point materials, said method comprising the steps of:
(1) providing a block that is to be finished to create a joint, wherein the block is comprised of ferrous alloys, non-ferrous alloys, superalloys or high melting point materials;
(2) providing a first rod and a second rode to be joined to the block, wherein the first rod and the second rod are comprised of ferrous alloys, non-ferrous alloys, superalloys or high melting point materials;
(3) forming a first aperture and a second aperture in the block, wherein the first and the second apertures only extend partially into the block;
(4) disposing a portion of the first rod into the first aperture, and disposing a portion of the second rod into the second aperture; and
(5) functionally friction stir welding the first rod and the second rod to the block to thereby create a solid state assembly therebetween.

18. The method as defined in claim 17 wherein the method further comprises the steps of:
(1) boring an aperture through a center axis of the first rod and into the block; and
(2) boring an aperture through a center axis of the second rod and into the block, such that the aperture through the first rod and the second rod meet within the block.

19. A method for creating a solid state joint using ferrous alloys, non-ferrous alloys, superalloys or high melting point materials, said method comprising the steps of:
(1) providing a block that is comprised of ferrous alloys, non-ferrous alloys, superalloys or high melting point materials;
(2) providing a first tube and a second tube to be joined to the block, wherein the first tube and the second tube are comprised of ferrous alloys, non-ferrous alloys, superalloys or high melting point materials;
(3) forming a first aperture and a second aperture in the block;
(4) disposing a portion of the first tube into the first aperture, and disposing a portion of the second tube into the second aperture; and
(5) functionally friction stir welding the first tube and the second tube to the block to thereby create a solid state assembly therebetween.

20. A method for creating a solid state joint from stainless steel in order to form a frame of a bicycle, said method comprising the steps of:
(1) providing a block that is comprised of stainless steel;
(2) providing a first tube and a second tube to be joined to the block, wherein the first tube and the second tube are comprised of stainless steel;
(3) forming a first aperture and a second aperture in the block;
(4) disposing a portion of the first tube into the first aperture, and disposing a portion of the second tube into the second aperture; and
(5) functionally friction stir welding the first tube and the second tube to the block to thereby create a solid state joint of a bike frame.

21. The method as defined in claim 20 wherein the method further comprises the step of machining the solid state joint to remove unwanted material therefrom.

22. The method as defined in claim 21 wherein the method further comprises the step of boring apertures in the first tube and the second tube where they are joined together with the block, wherein the apertures meet within the joint to thereby form a continuous aperture.

23. The method as defined in claim 22 wherein the method further comprises the step of machining at least one fillet in the solid state joint when removing unwanted material therefrom to thereby increase structural strength of the solid state joint.

24. The method as defined in claim 21 wherein the method further comprises the step of rigidly mechanically coupling the first tube to the block and the second tube to the block to thereby prevent movement of the first tube and the second tube when they are friction stir welded to the block.

25. The method as defined in claim 24 wherein the method further comprises the steps of:
(1) forming the first groove and the second groove to have a threaded groove; and
(2) forming the first tube and the second tube to have a threaded length where the first tube and the second tube are joined to the block, such that the first and second tubes can be mechanically screwed into the block.

26. The method as defined in claim 24 wherein the method further comprises the steps of:
(1) heating the block so that the block expands;
(2) inserting the first and second tubes into the first and second grooves of the heated and expanded block; and
(3) allowing the heated block to cool and contract around the first and the second tubes.

27. The method as defined in claim 24 wherein the method further comprises the steps of:
(1) disposing apertures through the block and the first tube, wherein the apertures are coaxial; and
(2) disposing a pin through the apertures to thereby hold the first tube in place within the block.

28. The method as defined in claim 25 wherein the method further comprises the steps of:
(1) disposing apertures through the block and the second tube, wherein the apertures are coaxial; and
(2) disposing a pin through the apertures to thereby hold the second tube in place within the block.

29. The method as defined in claim 20 wherein the method further comprises the steps of:
(1) forming the first and the second grooves with a cross-section of an ellipsoid; and
(2) forming the first and the second tubes with a cross-section of an ellipsoid.

30. The method as defined in claim 20 wherein the method further comprises the step of leaving a center plug in the middle of the first and the second circular grooves, wherein the plugs slide into the first and the second tubes when the first and second tubes are coupled to the block.

31. The method as defined in claim 20 wherein the method further comprises the step of selecting a shape for the block from any convenient shape that enables the first tube and the second tube to form a desired angle within the block.

32. The method as defined in claim 20 wherein the method further comprises the step of forming the first groove so that the first groove is disposed opposite of but coaxially aligned with the second groove.

33. The method as defined in claim 20 wherein the method further comprises the step of forming the first groove so that the first groove is disposed at an oblique angle with respect to the second groove.

34. The method as defined in claim 20 wherein the method further comprises the step of forming the first groove so that the first groove is disposed at a right angle with respect to the second groove.
